(19) United States
(12) Patent Application Publication
(10) Pub. No.: US 2008/0096767 A1
(43) Pub. Date: Apr. 24, 2008

(54) Method For Expanding The Dynamic Detection Range In Microarrays

(75) Inventor: Heinz Gerhard Kohn, Hamburg (DE)

Correspondence Address: KNOBBE MARTENS OLSON & BEAR LLP, 2040 MAIN STREET, FOURTEENTH FLOOR, IRVINE, CA, 92614, US

(73) Assignee: Eppendorf AG, Hamburg (DE)

(21) Appl. No.: 11/575,006

(22) PCT Filed: Aug. 17, 2005
(86) PCT No.: PCT/EP05/08929

§ 371 Date: Oct. 2, 2007

(30) Foreign Application Priority Data
Sep. 10, 2004 (DE) 10 2004 043 870.6

(51) Int. Cl. C40B 30/04; C40B 60/12

(52) U.S. Cl. 506/9; 506/39

(57) ABSTRACT

The present invention relates to microarrays, in which the probes are each applied multiple times and in different concentrations to a carrier. In particular, the present invention relates to a method for detecting specific molecules in a biological sample, using which the dynamic range of the detection is expanded.

### CROSS-REFERENCE TO RELATED APPLICATIONS

This application is a U.S. National Phase of International Application No.: PCT/EP2005/008929, filed Aug. 17, 2005, designating the U.S. and published not in English as WO 2006/027088 on Mar. 16, 2006, which claims the benefit of German Application No.: 10 2004 043 870.6, filed Sep. 10, 2004.

### FIELD OF THE INVENTION

The present invention relates to microarrays, in which the various probe molecules are each applied multiple times and in different concentrations to a carrier. In particular, the present invention relates to an improved method for detecting specific target components in a sample.

### DESCRIPTION OF THE RELATED ART

Because of the greater and greater quantity of data about biological systems, in particular cellular systems, scientists are increasingly faced with the problem of assaying as many of the known parameters as possible, such as the transcription of nucleic acids or the translation into proteins, using the particular assays to be performed.

Typical (molecular) biological methods normally contain experiments which stop at a specific biological target component, such as a gene or the mRNA derived therefrom, or a protein, which permits evaluation of processes in the cell, in particular with the participation of multiple biological target components, only under more difficult conditions.

In recent years, microarrays have been developed, with the aid of which multiple biological target molecules may be assayed simultaneously. Microarrays of this type essentially contain a carrier, such as a glass or silicon plate or a membrane, on which, an array of biological components of known composition, such as nucleic acids or proteins, known as the probe (molecules), are applied at predetermined spots in a predetermined configuration. The size of these spots is normally approximately 20 μm, so that a carrier may contain multiple such spots. The microarrays allow rapid and cost-effective assaying of the gene expression and/or genetic changes in a sample.

If the probes are nucleic acids, suitable nucleotides of known base sequence in a length of approximately 20 to 2000 bases are immobilized (spotted) in a predetermined configuration on the carrier. Subsequently, the sample to be assayed is brought into contact with the carrier under conditions which allow hybridization of complementary strands. Non-complementary strands, which do not enter into hybridization with the probes on the carrier, are removed. The areas on the microarrays which contain nucleotide double strands are ascertained and allow a conclusion about the sequence in the starting sample.

This is comparably true for proteins as probes. For this purpose, suitable proteins, such as peptides or antibodies, are immobilized (spotted) on the carrier and subsequently the carrier is brought into contact with the sample to be assayed. Biological components which have bound to the probes are subsequently detected using typical methods.

“Screening methods” of this type, in which multiple different probes are brought into contact simultaneously with the sample to be assayed in a single batch, are also capable of determining the quantity of the biological components in the sample which are captured by the probe.

If the target components in the biological sample are present in a sufficient quantity, the assay may typically be performed directly.

However, problems result during the performance if the sample contains a large quantity or also a small quantity of target components, because the signal which is generated in the detection method of the captured target molecules is not linear in relation to the number of the molecules, but rather sigmoid as a result of the technology.

If a large quantity of target molecules is contained in the sample, the determination may not be performed quantitatively because of a saturation effect of the signal during the detection. In this case, the assay must be repeated with less sample material, which is itself sometimes difficult or even impossible because of the availability of the sample.

In addition, even if the target components are present in the sample in a very small concentration, the signal may not be analyzable, because it is too weak. A possibility for bypassing this is to amplify the target molecules in the sample before bringing them into contact with the microarray, for example, with a nucleic acid using a PCR reaction. It is in turn disadvantageous here that an amplification in the sample may be subject to error, while a prior purification, such as removal of protein material, may itself introduce errors. Another known possibility if small quantities of target component(s) are present is to amplify the signal itself.

Both procedures of amplification are accompanied by the risk, however, of again reaching a saturation range of the detection upon the determination.

Therefore, an object of the present invention is to provide improved means, by which the detection range of target components may be expanded when using a microarray.

### SUMMARY OF THE INVENTION

This object is achieved according to the present invention by providing a microarray, which has multiple probe molecules provided immobilized on a carrier in a specific configuration, one species of a probe molecule being provided at least three times on the carrier, and one species of probe molecule being provided in different concentrations.

### BRIEF DESCRIPTION OF THE DRAWINGS

FIG. 1 shows a graph which shows the signal strength for fluorescence samples as a function of the concentration.

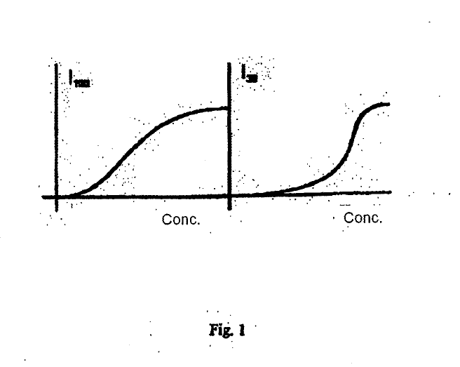

FIG. 2 schematically shows a microarray having 3 probes, which were applied in different concentrations.

### DETAILED DESCRIPTION OF THE PREFERRED EMBODIMENT

In the assays which have resulted in the present invention, it was shown that by providing at least 3 probes of identical specificity on the array, which are provided in different concentrations, the dynamic range of the detection in which a quantitative detection of the target components is possible may be expanded, so that samples which contain a large quantity of target components and also samples which contain a small quantity of target components may be quantitatively detected reliably using an assay.

The carrier used here may be any commercially available carrier usable for the purpose of binding target molecules to probe molecules, including membranes, metal carriers, plastic materials, beads, or glass. Furthermore, any method known in the prior art, which temporarily or permanently causes immobilization, fixing, or adhesion of the probe molecules to a spot or in an area of the carrier, for example, with formation of covalent, ionic, or metal-organic bonds, bonds based on van der Waals forces, or enzyme-substrate interactions, or “affinity bonds”, may be used for applying probe molecules to the carrier. Of course, arbitrary spacer molecules, such as spacers based on polymers, may be situated between the carrier and the probe molecules applied to the carrier. In addition, carriers based on self-assembling layer systems are also suitable for performing the present invention. The application may also be achieved in the present case using automated methods.

The probe molecules on the array are typically nucleotides having different sequences, but may also be a binding partner in a system, such as antigen-antibody.

According to a preferred embodiment, the microarray has the same probe molecule, i.e., probe molecules having identical specificity, in a number from 3 through 10, more preferably 3 through 7, still more preferably 3 through 5, spotted on the carrier. The concentration differences between the individual applied probes at the particular spots may vary depending on the number of spots containing the identical probes, by a factor of 1, 10, or 100, for example. Preferably, the spot having the highest concentration is to have at least twice as high a concentration as the spot having the lowest concentration of the same probe molecule. Thus, for example, in the case of using 10 probe molecules of identical specificity, i.e., 10 spots on which the same probe molecules were immobilized on the array, on which probe molecules of identical specificity are located, a concentration gradient of 10% may be provided in each case, the spot having the highest concentration being set as 100%. In the event three spots of the identical probe molecules are used, which is preferable because of the spatial configuration on the array, there is a concentration gradient of 100%, 75%, and 50%.

In general, any currently typical methods may be used as a detection method, such as staining methods using silver, fluorescence, or enzymatic reactions, for example, using horseradish peroxidase.

If fluorescent pigments are used, the dynamic range may additionally also be expanded by reducing the excitation intensity in steps. For example, if it is established during a measurement that saturation has already been reached and/or the linear range has been left, the measurement range may be returned back into the linear range by reducing the excitation intensity.

In addition, the present invention relates to a method for quantitatively determining target molecules in a sample, which includes bringing a sample into contact with a microarray, which has specific probe molecules at predetermined spots, under conditions which allow binding of the target molecules to the probe molecules. Every species of a probe molecule is provided on the carrier at least three times at different spots and in different concentrations.

The detection of the target molecules bound to the carrier and/or their quantity may be performed according to typical methods, such as staining methods using silver or fluorescent pigments or coloration by enzymatic reactions, for example, with the aid of horseradish peroxidase. The stain thus obtained is then analyzed quantitatively by commercially available hardware and software products.

### EXAMPLE

A DNA microarray was produced having three different probes A, B, and C. Three spots were produced using each probe. The three spots of each probe differed in concentration. The first spot of the probe A was spotted at a defined concentration, and set as 100%. For the further spots, the solution containing the probes was diluted in such a way that the original concentration was reduced to 70% and 50%, respectively.

An analogous method was used for the probes B and C.

Thus, 9 spots were obtained in the example:

| | | | |
|---|---|---|---|
| A | 100% | 70% | 50% |
| B | 100% | 70% | 50% |
| C | 100% | 70% | 50% |

The microarray thus obtained was hybridized using a solution which contained the complementary three strands of the applied probes B and C under standard conditions, 1½ times the quantity being used for the probe C.

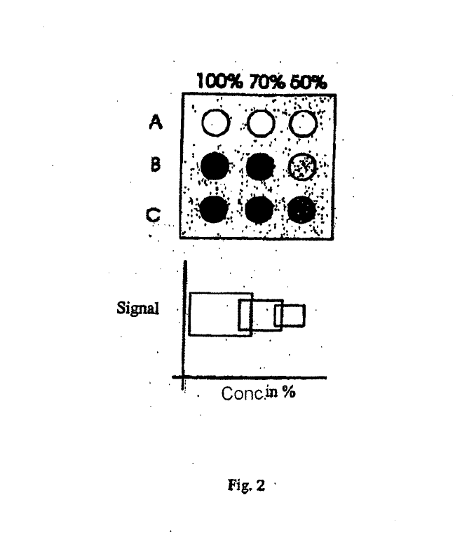

The hybridized molecules were detected using the known method of silver staining. The signals are to be proportional to the quantity of hybridized DNA. The result shown in FIG. 2 was obtained, from which it is obvious that the different concentrations of DNA in the spots significantly increased the dynamic range.

1. A microarray containing
a carrier; and
multiple probe molecules specific for certain target molecules applied in a specific configuration,
wherein every probe molecule specific for a certain target molecule is applied to the carrier at least three times at different spots of the configuration and in different concentrations.

2. The microarray according to claim 1, wherein the probe molecules specific for certain target molecules are applied to the carrier in a number in the range from 3 through 7 times.

3. The microarray according to claim 1, wherein a concentration of particular identical target molecules at the different spots on the carrier differs by a factor in a range from 1 to 100.

4. The microarray according to claim 1, wherein each probe molecule is provided on the carrier three times and the concentrations of the applied probe molecules are 100%, 75%, and 50%, each in relation to the highest concentration.

5. (canceled)

6. (canceled)

7. A method for quantitative determination of a target component in a sample, which comprises:
bringing the sample into contact with the microarray according to claim 1, and
determining binding of target component at a spot on the array.

8. The method according to claim 7, wherein the binding is determined by silver staining, fluorescence, or enzymatic staining.

9. The method of claim 2, wherein the probe molecules specific for certain target molecules are applied to the carrier in a number in the range from 3 through 5 times.

10. The method of claim 3, wherein the concentration of the particular identical target molecules at the different spots on the carrier differs by a factor in the range from 1 to 10.
